(19) United States
(12) Patent Application Publication
(10) Pub. No.: US 2011/0267068 A1
(43) Pub. Date: Nov. 3, 2011

(54) ENERGY STORAGE LEVEL INDICATION CIRCUIT

(76) Inventors: Jian Xu, Windsor (CA); John Gerard Finch, Livonia, MI (US)

(21) Appl. No.: 12/772,513

(22) Filed: May 3, 2010

(51) Int. Cl. G01N 27/416

(52) U.S. Cl. 324/427

(57) ABSTRACT

An energy storage level indication circuit includes an energy storage device and a radio control module operable to transmit a wireless heartbeat signal at a rate indicating an amount of energy stored in the energy storage device.

### BACKGROUND

This application relates to energy storage, and more particularly to a method of indicating an amount of energy stored in an energy storage device.

In energy-harvesting applications it is desirable to monitor an energy level of an energy storage device of a remote sensor so that appropriate actions can be taken before the sensor is shut down. Current remote sensors have simply included a preset threshold to turn ON/OFF the sensor, or have special circuits that transmit wireless signals including encoded information to communicate a stored energy level to a central controller at the cost of extra energy consumption.

### SUMMARY

In a non-limiting embodiment, an energy storage level indication circuit includes a first energy storage device having a first capacity and a second energy storage device having a second capacity lower than the first capacity. The first energy storage device charges the second energy storage device. A signal generator is operable to transmit a heartbeat signal in response to the second energy storage device being charged to a threshold. The rate of heartbeat signal transmission indicates an amount of energy stored in the first energy storage device.

In a non-limiting embodiment, an energy storage level indication circuit includes an energy storage device and a radio control module operable to transmit a wireless heartbeat signal at a rate indicating an amount of energy stored in the first energy storage device.

In one non-limiting embodiment, a method of indicating an amount of energy stored in an energy storage device includes harvesting energy from environmental conditions using an energy harvester, charging an energy storage device using the harvested energy, and transmitting a wireless heartbeat signal at a rate indicating an amount of energy stored in the energy storage device.

These and other features of the present invention can be best understood from the following specification and drawings, the following of which is a brief description.

### BRIEF DESCRIPTION OF THE DRAWINGS

FIG. 1 schematically illustrates an example energy storage level indication circuit.

FIG. 2 schematically illustrates another example energy storage level indication circuit.

### DETAILED DESCRIPTION

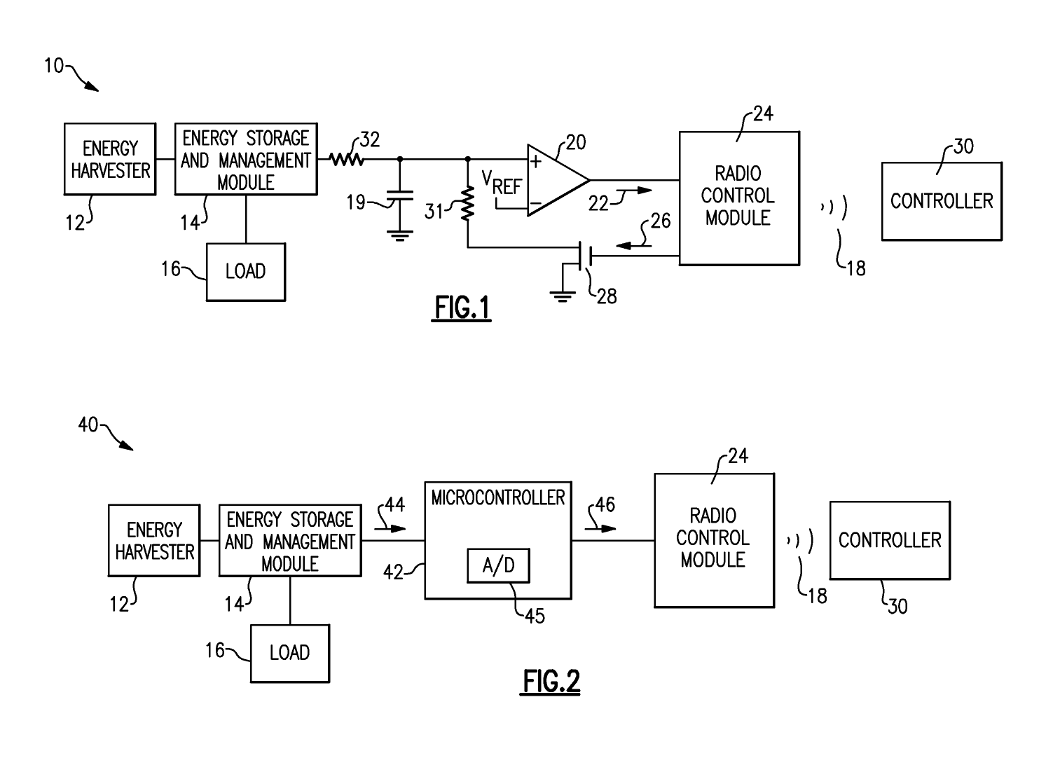

FIG. 1 schematically illustrates an example energy storage level indication circuit 10. The circuit 10 includes an energy harvester 12 operable to harvest energy from environmental conditions. The energy harvester 12 may include a photovoltaic cell, a thermal energy harvester, a hydroelectric energy harvester, or a mechanical energy harvester, for example, or may include a plurality of one of these devices or a may include a combination of these devices.

An energy storage and management module 14 manages and stores energy harvested by the energy harvester 12. The energy storage and management module 14 is operable to selectively power a load 16 using the harvested energy. The load 16 may include one or more sensors, for example. Of course, other loads could be used.

The circuit 10 is operable to transmit a heartbeat signal 18 to indicate an amount of energy stored in the module 14. The heartbeat signal 18 is transmitted such that the rate of transmission of the heartbeat signal 18 indicates the amount of energy stored in the module 14 and no actual information about the energy level is stored or encoded in the actual heartbeat 18. The voltage of module 14 is used to charge a capacitor 19. In one example the energy storage capacity of the capacitor 19 is much less than that of the energy storage and management module 14 (e.g. within a range of 0.01%-10% of the capacity of module 14). A comparator 20 compares the voltage of capacitor 19 to a voltage threshold (“V_{ref}”).

When the voltage of capacitor 19 is below the voltage threshold, the comparator 20 outputs signal 22 as a logic low, and radio control module 24 does not transmit the signal 18. However, when the voltage of capacitor 19 exceeds the voltage threshold, the comparator 20 outputs signal 22 as a logic high, commanding the radio control module 24 to transmit the heartbeat signal 18.

As the transmission of signal 18 is initiated, the radio control module 24 sends signal 26 to turn a solid state switch 28 ON, which quickly discharges capacitor 19 through current limiting resistor 31. The capacitor 19 will then recharge, and the signal 18 will be repeatedly transmitted as the capacitor 19 charges beyond the voltage threshold. Because the charge time of capacitor 19 is proportional to the voltage level of module 14, the rate of transmission of signal 18 indicates the amount of energy stored in the module 14. A controller 30 receives the signal 18 and is operable to determine the rate of transmission of the signal 18 and to ultimately determine the amount of energy stored in module 14. The capacitor 19, resistor 32, and the comparator 20 having the voltage threshold define the period for the heartbeat signal 18, and therefore may be selected to achieve a desired period for the signal 18.

FIG. 2 schematically illustrates another example energy storage level indication circuit 40 that is also operable to transmit the signal 18 indicating an amount of energy stored in the module 14. Like the circuit 10, the circuit 40 also includes the energy harvester 12, energy storage and management module 14, the load 16, the radio control module 24 that transmits signal 18, and the controller 30. However, instead of using the comparator 20 to perform a threshold comparison, the circuit 40 uses an analog-to-digital converter 45 of microcontroller 42 to determine when to transmit the signal 18, and at what rate to transmit the signal 18.

The microcontroller 42 receives an analog signal 44 from module 14 that indicates the amount of energy stored in the module 14. The microcontroller 42 includes the analog-to-digital converter 45 that converts the analog signal 44 to a digital value representative of the amount of energy stored in the module 14. The microcontroller compares the digital value to a predefined energy threshold to determine an appropriate rate of transmission of signal 18. The microcontroller then transmits signal 46 to command the radio control module 24 to transmit signal 18 at the determined rate that is representative of the amount of energy stored in module 14. However, it would be possible for the analog-to-digital converter 45 to be a standalone unit such that the radio control module 24 determines when and at what rate to transmit the signal 18, or the analog-to-digital converter 45 could be included within the radio control module 24.

In each of the circuits 10, 40 the controller 30 receives the signal 18 and may determine the rate of the signal 18 to determine the amount of energy stored in energy storage and management module 14. In an environment that included a plurality of energy harvesters 12, a single controller 30 could receive signals 18 from a plurality of sources such that the controller 30 could be aware of a voltage level of a plurality of remote sensors. Also, because the plurality of energy harvesters 12 may harvest energy at varying rates due to different environment conditions, the signals 18 sent to the controller 30 would likely arrive in a random order, preventing signal collisions that may otherwise occur if all signals 18 were sent simultaneously.

In one example the controller 30 is operable to determine a change in the rate of the signal 18 over time such that an amount of energy available to the energy harvester 12 may be determined. For example, if the energy harvester 12 included a solar cell, the change in the rate of signal 18 over time could be used to determine an amount of available light at the location of the energy harvester 12.

Also, although the energy storage device 19 has been described as being charged from an energy harvester 12 and an energy storage and management module 14, it is possible that the energy storage device could be charged by the output of a sensor (e.g. a passive infrared sensor having a low voltage output).

In the prior art signals having encoded energy storage data would be transmitted. These signals are larger than the simple heartbeat signal 18, and therefore take more power to transmit. Additionally, these prior art signals require upstream processing because the storage information must be determined and encoded. By transmitting a heartbeat signal 18 instead of a signal having encoded energy storage data, the circuits 10, 40 defer these calculations to the controller 30 so that energy harvested by the energy harvester 12 is used more efficiently.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. An energy storage level indication circuit, comprising:
a first energy storage device having a first capacity;
a second energy storage device having a second capacity lower than the first capacity, the second energy storage device being charged by the first energy storage device; and
a signal generator operable to transmit a heartbeat signal in response to the second energy storage device being charged to a threshold, wherein the rate of heartbeat signal transmission indicates an amount of energy stored in the first energy storage device.

2. The system of claim 1, wherein at least one of the energy storage devices includes a capacitor.

3. The system of claim 1, wherein a faster signal transmission rate indicates a larger amount of energy stored in the first energy storage device, and a slower signal transmission indicates a smaller amount of energy stored in the first energy storage device.

4. The system of claim 1, wherein the first energy storage device is charged from an energy harvester operable to harvest energy from environmental conditions.

5. The system of claim 4, wherein the energy harvester includes at least one of a photovoltaic cell, a thermal energy harvester, a hydroelectric energy harvester, or a mechanical energy harvester.

6. The system of claim 4, wherein the heartbeat signal is a wireless signal, and wherein a controller receives the wireless signal and determines an amount of energy available to the energy harvester by analyzing changes in the rate of signal transmission over time.

7. The system of claim 1 wherein the heartbeat signal is a wireless signal, and wherein a controller receives the wireless signal and determines the rate of signal transmission to determine the amount of energy stored in the first energy storage device.

8. The system of claim 1, wherein the first energy storage device is charged from a voltage output of a sensor.

9. The system of claim 1, the system further including a comparator and a solid state switch, the comparator comparing a charge of the second energy storage device to a threshold, and commanding the signal generator to transmit the heartbeat signal in response to the charge of the second energy storage device exceeding the threshold, the solid state switch discharging the second energy storage device concurrently with the signal transmission.

10. An energy storage level indication circuit, comprising:
an energy storage device; and
a radio control module operable to transmit a wireless heartbeat signal at a rate indicating an amount of energy stored in the energy storage device.

11. The system of claim 10, including a controller operable to receive the wireless signal and determine the rate of signal transmission to determine the amount of energy stored in the energy storage device.

12. The system of claim 10, wherein the energy storage device is charged from an energy harvester operable to harvest energy from environmental conditions.

13. The system of claim 12, wherein the controller is also operable to determine an amount of energy available to the energy harvester by analyzing changes in the rate of signal transmission over time.

14. The system of claim 12, wherein the energy harvester includes at least one of a photovoltaic cell, a thermal energy harvester, a hydroelectric energy harvester, or a mechanical energy harvester.

15. The system of claim 10, including:
an analog to digital converter operable to measure an amount of energy stored in the energy storage device and to output a digital value representing the amount of energy stored in the first energy storage device, wherein either the radio control module or a microcontroller compare the digital value to a predefined energy threshold to determine a signal transmission rate.

16. A method of indicating an amount of energy stored in an energy storage device:
harvesting energy from environmental conditions using an energy harvester;
charging an energy storage device using the harvested energy; and
transmitting a wireless heartbeat signal at a rate indicating an amount of energy stored in the energy storage device.

17. The method of claim 16, including:
receiving a plurality of the heartbeat signals;
determining a rate of transmission of the heartbeat signals; and
determining the amount of energy stored in the energy storage device in response to the rate of transmission.

18. The method of claim 17, including:
determining an amount of energy available to the energy harvester by analyzing changes in the rate of signal transmission over time.

19. The method of claim 16, wherein said charging an energy storage device using harvested energy includes:
charging a first energy storage device having a first capacity using the harvested energy; and
charging a second energy storage device using energy from the first energy storage device, the second energy storage device having a second capacity lower than the first capacity.

20. The method of claim 19, the method including:
comparing a charge of the second energy storage device to a threshold, wherein said step of transmitting a wireless heartbeat signal is performed in response to the charge of the second energy storage device exceeding the threshold.

21. The method of claim 20, wherein said comparing a charge of the second energy storage device to a threshold includes:
A) using a comparator to compare a voltage of the second energy storage device to the threshold;
B) commanding a signal generator to transmit the heartbeat signal in response to the voltage of the second energy storage device exceeding the threshold;
C) commanding a solid state switch to discharge the second energy storage device; and
D) selectively repeating steps (A)-(C).

22. The method of claim 16, the method including:
receiving an signal indicative of a charge level of the energy storage device;
processing the signal to a threshold to determine a charge level of the energy storage device; and
determining a rate of signal transmission in response to the charge level.
